(19) United States
(12) Patent Application Publication
(10) Pub. No.: US 2012/0179756 A1
(43) Pub. Date: Jul. 12, 2012

(54) METHOD AND SYSTEM FOR PLATFORM AGNOSTIC ELECTRONIC SIGNATURE

(76) Inventor: Michael Colella, Twp of Washington, NJ (US)

(21) Appl. No.: 13/345,659

(22) Filed: Jan. 6, 2012

Related U.S. Application Data
(60) Provisional application No. 61/430,943, filed on Jan. 7, 2011.

(51) Int. Cl. G06F 15/16

(52) U.S. Cl. 709/204

(57) ABSTRACT

A method and system for capturing, authenticating and transmitting a person's script signature during an electronic transaction between at least two parties over the Internet is conducted by a third party service provider that observes, facilitates, authenticates the transaction between the two parties. A first party provides electronic data to the second party for review. The second party wishing to provide a script signature as an acknowledgement and or agreement to the provided data receives an electronic envelope from the service provider. The second party inputs via cursor movement, a touch screen, or digitizing pad an electronic image of his physical script signature. The script signature image is captured electronically and transmitted to the service provider for further processing. Thus the entire transaction is consummated electronically.

### CROSS REFERENCES TO RELATED APPLICATIONS

This non-provisional patent application claims a priority benefit to U.S. Provisional Application No. 61/430,943 entitled “METHOD AND SYSTEM FOR PLATFORM AGNOSTIC ELECTRONIC SIGNATURE” filed in the United States Patent and Trademark Office on Jan. 7, 2011 by a common Inventor to this instant application, Michael Colella. Further the above named Provisional Application is hereby incorporated by reference.

### STATEMENT REGARDING FEDERALLY SPONSORED RESEARCH

Not Applicable

### REFERENCE TO APPENDIX

Not Applicable

### BACKGROUND OF THE INVENTION

The present invention relates to the need for script signatures on various paper documents. Historically paper documents such as contracts, sales agreements, work orders, designs, and legal documents were not complete or in effect until they had a script signature of the party or parties involved. The relative recent invention of the Internet, transmission of documents in digital form, and desire to eliminate the unnecessary printing of documents has made the process of incorporating a script signature a difficult step.

### FIELD OF THE INVENTION

The present invention relates to a method and process to generate and capture visual evidence that a party witnessed and or agreed to certain documents and or events. Toward that goal, the Inventor has developed a method and process of capturing a script signature in digital form, authenticating such, attaching the digital script signature to an event or document, and transmitting the entire package to the appropriate recipients over an electronic medium.

### SUMMARY OF THE INVENTION

A digital script signature service provider operates one or more servers on the Internet to provide the digital script signature service for his corporate client(s), the ‘company’. The company desires to transact business in a paperless environment by eliminating unnecessary printing and or faxing of documents. Further the company wishes to avoid the necessary expense and time of using couriers and/or the US mail system to transport documents between interested parties. Thus the company wishes to transmit documents and or other electronic data to a second party via the Internet, who may be another company, employee, client, and/or any interested party. Both the company and the second party desire to affix a script signature to the electronic documents and/or data signifying an acknowledgment and or and an agreement which may be legally binding.

Prior to this invention, the subject documents, if transmitted via the Internet, had to be printed at the recipient's site. The recipient would then physically sign the documents using a pen or other writing instrument, with his script signature. The documents would then be faxed back to the originating company, where they would be printed a second time. An alternative method was to print the documents at the originating company, put them into an envelope for physical delivery by a common carrier such as UPS or FedX, or the US Mail system. Once received by the second party, the documents would be signed and copied with the originals being returned by courier to the originating company.

All of this time and expense can be eliminated if there was a method and process for the receiving party to attach his script signature to the electronic document upon receipt.

This invention provides a method and process for the receiving party to open and view the subject electronic documents, and subsequently attach their script signature in digital form to the subject documents thus verifying an acknowledgment and or agreement to the documents or subject event. The subject documents are then transmitted electronically along with the digital script signature back to the originating party. The electronic package of documents and digital script signature can be maintained in electronic form by either party for as long as they desire without ever having to print or physically transport a single piece of paper.

The advantages and features discussed above and other advantages and features will become apparent from the detailed description of the best mode for carrying out the invention that follows.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a computer screen shot of a website design introducing the invention;

FIG. 2 is a computer screen shot of a website design describing the features of the invention;

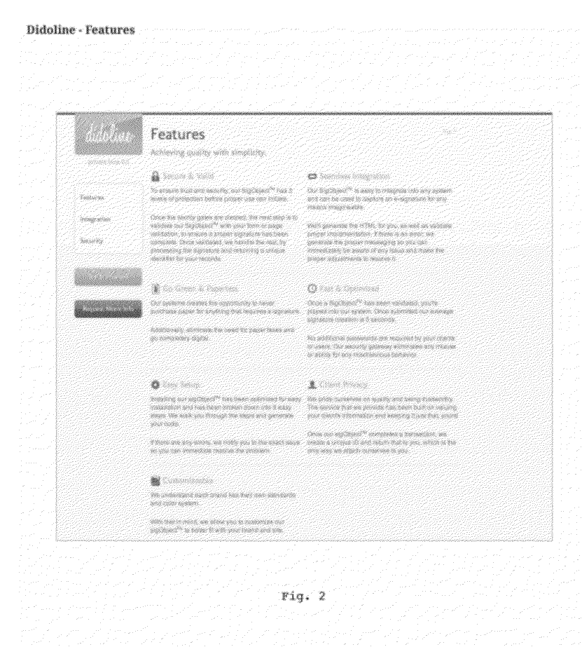

FIG. 3 is a computer screen shot of a website design describing the method of integration of the invention;

FIG. 4 is a computer screen shot of a website design describing the different elements of security used by the invention;

FIG. 5 is a data flow diagram illustrating the data paths of the invention;

FIG. 6 is a process flow diagram illustrating various steps of the invention; and

FIG. 7 is a process flow diagram illustrating various steps of the signature process.

FIG. 8 is a process flow diagram illustrating various steps of the signature authentication process.

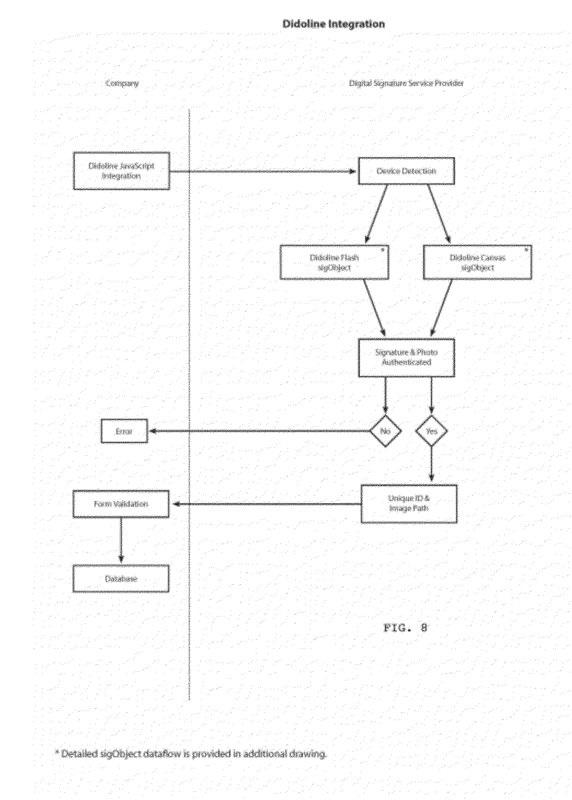

FIG. 9 is a data flow diagram illustrating various data paths of the signature authentication process.

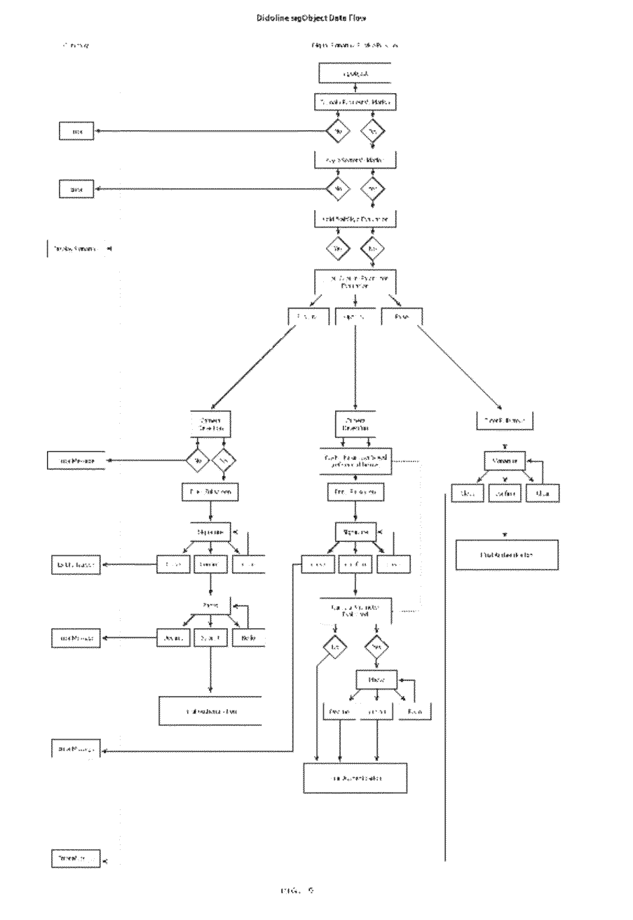

FIG. 10 is a screen shot of a signature object in a fully authenticated state.

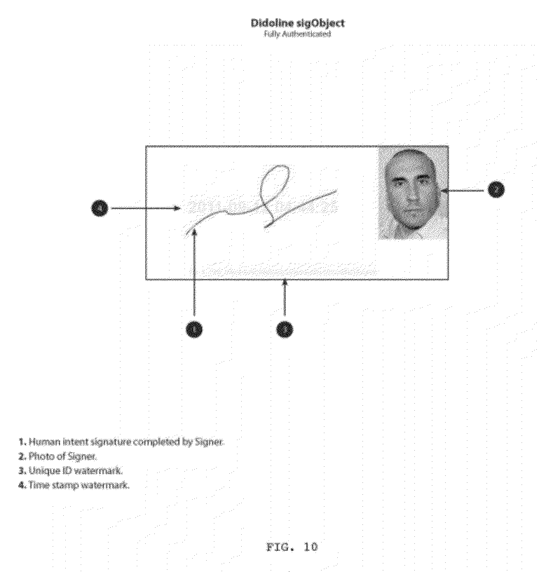

### DETAILED DESCRIPTION OF THE EMBODIMENT

### Digital Script Signatures

Usually when one hears mention of a ‘digital signature’, images of public keys, private keys, encryption algorithms, cryptographic hash functions and lots of hex code are brought to mind. However in this invention, I have produced a system and method that enables a person (signor) to transmit to another party an image of his script signature in acknowledgment of or agreement to an electronic event such as the review of the contract or other electronic document, image or events. Therefore as can be seen below I have produced a system and method to capture and transmit your ‘John Hancock’. This is called a ‘digital script signature’ or DSS.

### Overview

My invention is implemented over the Internet. The system is designed to work with many operating systems and all known Internet browsers. It will also work with other Web serving devices such as tablets, smart-phones, laptops and any other device that is Web-enabled.

The system is intended to support and provide authentication of commercial and business transactions over the Internet without the use of paper documents; that is to say without the printing, faxing, mailing and/or scanning of paper.

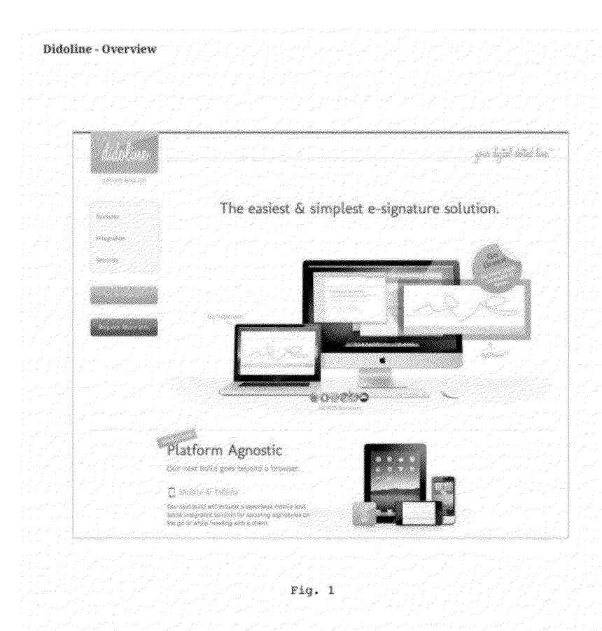

As can be seen in FIG. 1, a signer inputs a digital image of his script signature through some means such as cursor movement via a mouse, and transmits that image back to the company offering the business transaction.

### Features

The system has multiple levels of security so as to detect and prevent fraudulent transactions and to verify that script signatures provided by a signer are authentic. Security measures are implemented at the DSS server and on the company's website. Further security measures are incorporated into the signature envelope (sigObject) which is transmitted to the signer to capture his script signature.

Unique custom software code is generated for each company wishing to deploy the invention. The code is integrated into the company's website. The code supports and implements the signature transaction which will take place between the company's website, the signer, and the DSS server.

### Integration

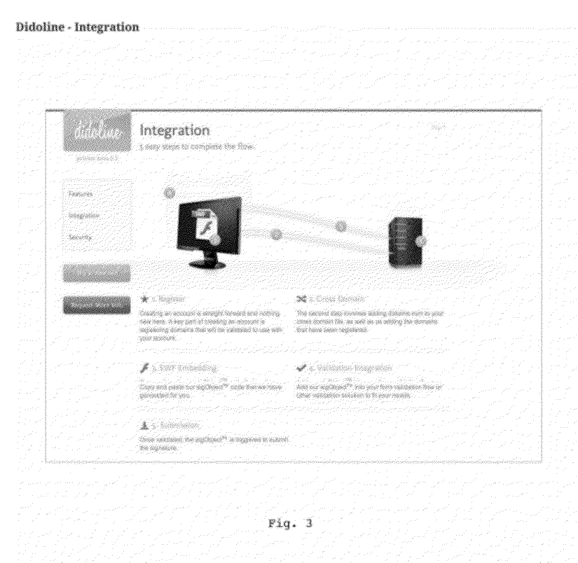

A signature event takes place when all three computing systems, i.e. the DSS server, the company server, and the signor's computer are in real-time communication. The DSS server remains transparent to the signer but is essential to the transaction. Referring to FIG. 3, prior to a signature event taking place, the company server needs register with the DSS server and then receive and integrate custom code from the DSS server into its website. Such code will facilitate the serving of the signature envelope (sigObject) when requested by a signer.

### Security

This method and system is comprised of four security validation points that allows signors to sign their name as if they were signing a paper document with precision and unmatched speed.

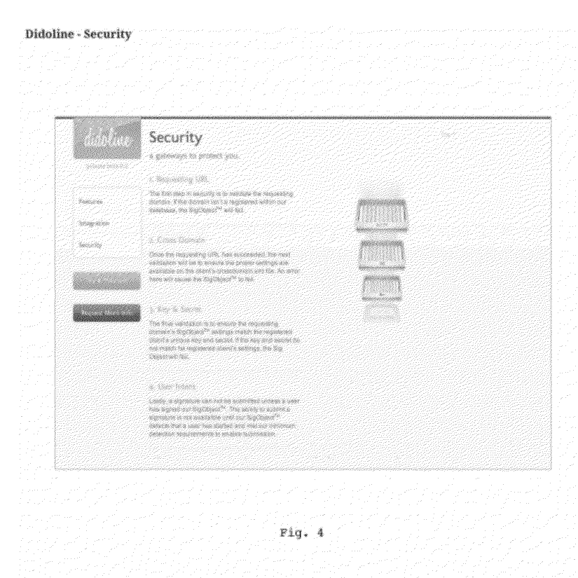

Referring now to FIG. 4, the system employs a four-part security validation that ensures proper usage of the signature envelope (sigObject).

Step one validation occurs during a cross-domain verification that grants access only to a properly registered web company.

Step two validation checks the requesting domain to ensure it has been registered in a database and cross-referenced to a known company.

Step three validation checks a unique key and secret generated for the requesting domain and cross-referenced to a known company.

Step four validation is an event listener to ensure a human signer is taking action to sign their name.

The system employs a JavaScript and PHP (Hypertext Processor) platform detection following the third step of security validation, key and secret cross-reference. On detection of a signor's web browser being served from a company computer, the digital script signature service (DSSS) server deploys a web signature envelope (sigObject) that is an Adobe® Flash® SWF (Shockwave Flash) file format. The signature envelope is transmitted over the Internet from the DSSS server to the signer's browser. On detection of the signer's tablet, mobile or touch device, the DSSS server deploys a mobile signature envelope (sigObject) that is an aggregate of JavaScript and an HTML 5 (Hypertext Markup Language) canvas element.

The DSSS server employs a camera validation process following the platform detection, allowing a photograph of the signer to be captured upon completion of a signature. If a signer has requested the usage of a signature/photo envelope (sigObject) to allow for photo capturing, the proper signature/photo envelope (sigObject) will be served.

The DSSS server employs a signature validation process upon submission of the signature envelope (sigObject). When the signer submits his signature from a computer (as opposed to another web-enabled device such as an iPad or smart phone), the signature validation process captures a timestamp, IP (Internet Protocol) address, geo location, operating system, browser and photo if applicable, all of which is stored in the DSSS server's database.

When the signer submits a signature from a mobile device, the signature validation captures a timestamp, IP (Internet Protocol) address, geo location, device model, browser and photo if applicable, all of which is stored in the DSSS server's database.

All signature envelope submissions generate a unique identification number, which is stored in the DSSS server database and cross-referenced to any of the other data elements in the transaction. The DSSS process uses this information to create a picture image in JPEG format (Joint Photographic Experts Group). The picture image contains the script signature of the signer, a watermark of the timestamp, an authentication stamp with selected information, unique identification number, and is transmitted to the Company to complete the signing transaction

The Company server transmits a unique verification message back to the signer to complete the transaction between the Company and signer.

The system is integrated into any existing web client or mobile device through the implementation of JavaScript, HTML, CSS and PHP contained within an iframe (inline frame).

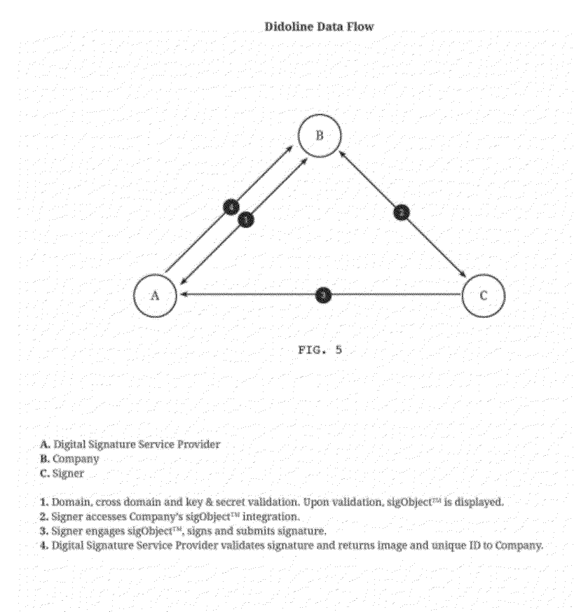

Now referring to FIG. 5 a data flow diagram of the signature event is shown. The signer C enters into a web transaction with the company B. The digital service provider A is transparent to the signer C during the transaction. When the signer C requests the signature envelope, it is transmitted 2 from the company B to signer C. After the signer C creates the digital image of his script signature on the signature envelope, the signer clicks of a ‘submit’ button and the signature envelope is transmitted 3 to the digital service provider A. The digital service provider A receives the signature envelope and performance verification and authentication processing on the contents. If the digital service provider A is satisfied with the contents of the signature envelope, he validates the transaction and transmits 4 the verification along with the signature envelope to the company B. In this manner the digital service provider A is able to monitor the transaction between the company B and the signer C.

### Digital Signature Service Provider Process Flow

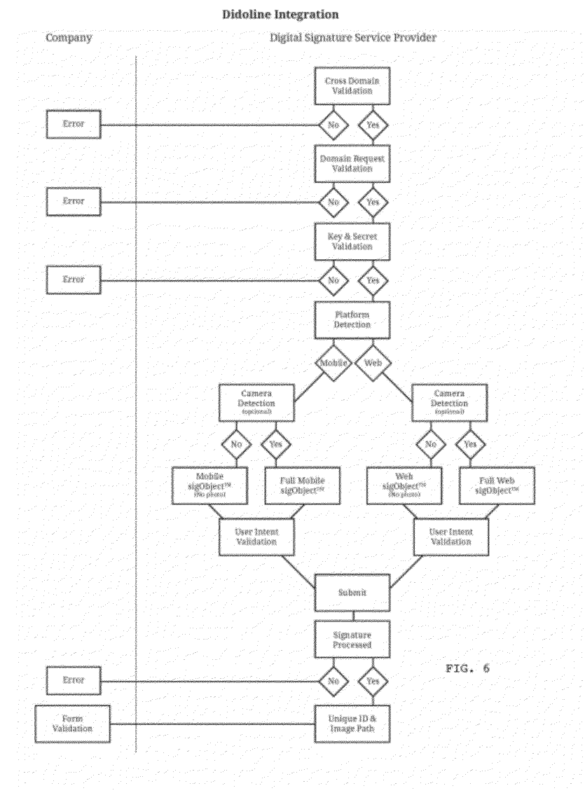

Referring now to FIG. 6 a process flow diagram is shown for the digital signature service provider. The process begins by verifying that the company website invoking a communication session with the service provider is authentic. The process then proceeds to service and monitor the signature event as it takes place between the three computer platforms. If the signature event is successful then a validation message is provided to the company server.

### Signature Envelope Data Flow

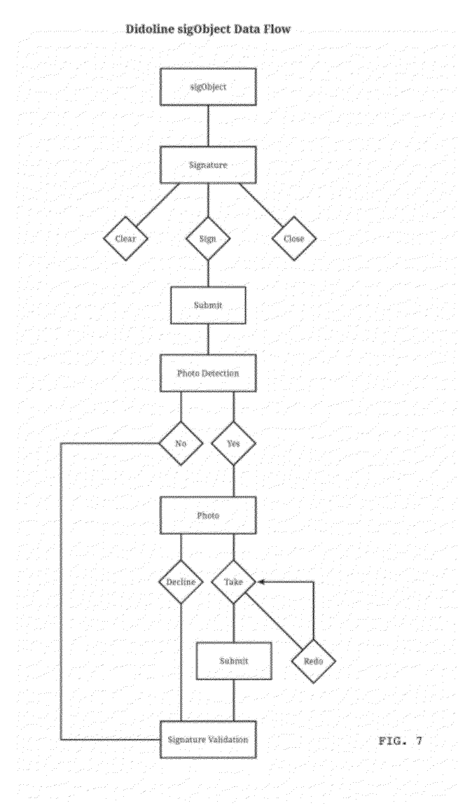

At some point during the electronic transaction between the company and the signer, the signer may request an opportunity to sign the document or to provide his signature for acknowledgment purposes. Referring now to FIG. 7, the company server transmits a signature envelope to the signer where it is displayed on his browser. The signer then inputs his script signature by imparting movement to some mechanical transducer such as a mouse, touchpad, or pen and tablet. The signer then has an optional opportunity to provide an authenticating photograph taken by an attached camera such as those integrated into a laptop and or a USB camera connected to a desktop computer. The signer then submits the signature envelope for processing. As stated above, the signature envelope is transmitted to digital signature service provider for validation.

### Registered Signatory Verification

One method for authenticating a script signature submitted over the Internet in a signature envelope is to compare the submitted image and other recorded data with an authenticated signature image on file. The signature and metadata relevant to and recorded for every signature event, e.g., time to initiate, time to completion, number of strokes, interval timings, failure events, geo location, signature client, etc., will be used to create a self-sustaining verification process. An on-file trusted signature image and signatory-provided secret key are to be used as an initial layer of identification, resulting in a single signatory match or match-fail. This result will be validated further by a proprietary algorithm applied to the metadata across all signature events associated with the signatory. The process will result in a pass-fail response from the DSSS system, which will include verification algorithm metadata, e.g., percentage confidence.

### Unregistered Signatory Verification

A second method for authenticating a script signature submitted over the Internet in a signature envelope is to compare the current submitted image and other recorded data against previously submitted signatures on file. Trending and confidence analysis is used to create weighing factors in an algorithm that analyzes the current submission against historical data.

The signature is to be used as an initial layer of identification, resulting in a set of one or more matching signatories. This set will be refined further by a proprietary algorithm applied to the metadata across all signature events for each signatory. The process will result in a percentage confidence response from the DSSS system, which will include all matching signatories along with verification algorithm metadata, e.g., percentage confidence.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

### API Overview

The sigObject, an inline widget, embeds itself onto a HTML web page by creating an instance of the DidolineSignature object via JavaScript. The widget utilizes either Flash or HTML5 Canvas as the presentation layer depending upon the viewing browser.

With this widget, one can sign their signature with their mouse on a desktop computer or with their finger or stylus on a mobile touch device or tablet. Once confirmed, the SigObject will generate a watermarked image, with a unique hash ID and image path.

The following documentation shows the public methods and properties available within the JavaScript objects that make up the widget.

### Creating An Object

To create a DidolineSignature object, you must pass in a DidoArgument object into the constructor that defines your unique client secret and key. They are required for the widget to work.

In a workflow, you can place the widget within a form with hidden fields. You can pass in the IDs of the hidden fields into the DidoArguments object, which would be populated with the signature hash ID and image path upon completion. The hidden fields then can be validated against to require a signature.

### Using Callbacks & Event Listeners

For more complex tasks, one can pass in callback functions within the DidoArguments object. In addition, the DidolineSignature object also dispatches events for completion or error. Both the callback functions and listening handler functions get passed a DidoEvent object that contains info on the target instance, completed signature hash ID and image path or error message.

sigObject Intergration

### Step 1: Registration

The first part of the process is to register. During the registration process you will have to fill in information that would be found in a typical registration process with an additional key set of data, your domains.

Your domains are one the most important assets to our technology and if a domain doesn't appear in our database, our sigObject™ will not properly validate, rendering your integration useless.

### Step 2: Set Your Doc Type

Set the proper HTML5 compliant document type at the top of the HTML page, in addition to the following meta tags after the start of the head.

### 2.0 DOCTYPE Sample Code.

<!DOCTYPE html>
<html lang=“en”>
<head>
<meta http-equiv=“Content-Type” content=“text/html; charset=UTF-8” />
<meta name=“viewport” content=“target-densitydpi=device-dpi; width=device-width;
initial-scale=1.0; maximum-scale=1.0; user-scalable=no;” />
<meta name=“apple-mobile-web-app-capable” content=“yes” />

Step 3: Didoline Core JavaScript

Copy & paste Didoline's core JavaScript and jQuery into the <head> of the page you would like to use a signature instance. If you already have the JQuery library on your site, you can leave it out, however we recommend you use our tried and tested version.

### 3.0 Didoline Integration JavaScript Sample Code.

// Didoline core js
<script type=“text/javascript” charset=“utf-8”
src=“http://www.didoline.com/dev/js/dido-
min.js”></script>
// jQuery
<script type=“text/javascript” charset=“utf-8”
src=“http://www.didoline.com/dev/js/jquery.js”></script>

### Step 4: Signature Instance Code

Create a DidolineSignature instance by passing in an argument object. For each instance, add two hidden fields within a form to validate the returned signature path and signature ID.

The argument object has the following properties:

key (String)—your unique client key code.*

secret (String)—you unique client secret code.*

inputSignatureID (String)—ID of the hidden field where the signature ID will be populated.

inputSignaturePath (String)—ID of the hidden field where the signature image path will be populated.
Your signature instance code will be generated for you within the “Integration” section of your user profile.

### 4.0 Didoline Signature Instance Sample Code.

```
// Didoline signature instance
<input name=“signaturePath” type=“hidden” id=“signaturePath” />
<input name=“signatureID” type=“hidden” id=“signatureID” />
<div id=“signatureFlash” class=“”>
  <script language=“JavaScript” type=“text/javascript”>
    // initailize DidolineSignature
    new DidolineSignature( {key:‘mykey’, secret:‘mysecret’,
inputSignatureID:‘signatureID’, inputSignaturePath:‘signaturePath’} );
  </script>
  <!--<div id=“signatureAlternativeContent”>
    <a href=“http://www.adobe.com/go/getflashplayer”><img
src=“http://www.adobe.com/images/shared/download_buttons/
get_flash_player.gif”
alt=“Get Adobe Flash player” /></a>
  </div> -->
</div>
```

### Step 5: Validate Hidden Fields

Validate the hidden fields. If they are empty, a user hasn't signed.

### Step 6: Save The ID & Path

Once the form is properly validated, save the unique ID and absolute image path in your database to reference at a later time. You can use our API to access all the meta data associated with the unique transaction.

Wherefore I claim:

1. A system and method for capturing a script signature in electronic form as part of an electronic transaction comprising:
a digital signature service server in communication with an electronic network;
a first party and at least a second party, both in communication with the electronic network;
the second party receiving electronic data from the first party during an electronic transaction between the two parties;
the second party further indicating to the first party a willingness to provide a script signature as an acknowledgment to the data;
the digital signature service server receiving and observing communications between the first and second party, and further providing an electronic envelope to the second party for capturing the a digital script signature;
the second party inputting his script signature in digital form into the envelope and submitting the envelope to the transaction process; and
the digital signature service server capturing the signed envelope and providing a copy of the signed envelope to the first party.
